(19) United States
(12) Patent Application Publication
(10) Pub. No.: US 2017/0118231 A1
(43) Pub. Date: Apr. 27, 2017

(54) ALERT HANDLING SUPPORT APPARATUS AND METHOD THEREFOR

(71) Applicant: FUJITSU LIMITED, Kawasaki-shi (JP)

(72) Inventors: Takuya Suzuki, Ota (JP); Yoichi Iwata, Yokohama (JP); Taichi Kimura, Inagi (JP); Takeshi Osako, Kawasaki (JP); Masahiko Tamiya, Higashikurume (JP)

(21) Appl. No.: 15/296,417

(22) Filed: Oct. 18, 2016

(30) Foreign Application Priority Data
Oct. 22, 2015 (JP) 2015-208096

(51) Int. Cl. H04L 29/06

(52) U.S. Cl. CPC H04L 63/1416; H04L 63/1441

(57) ABSTRACT

An apparatus measures, based on an operation performed by a user on first alert information displayed on a display section of a terminal device, a confirmation time period taken for the user to confirm the first alert information, and outputs, based on the confirmation time period, to the terminal device, pseudo attack information to make or feign an attack against the terminal device, while outputting second alert information including information indicating a method of handling the attack to the terminal device.

### CROSS-REFERENCE TO RELATED APPLICATION

This application is based upon and claims the benefit of priority of the prior Japanese Patent Application No. 2015-208096, filed on Oct. 22, 2015, the entire contents of which are incorporated herein by reference.

### FIELD

The embodiment discussed herein is related to alert handling support apparatus and method therefor.

### BACKGROUND

In recent years, with the widespread use of information and communications technology (ICT), a large amount of information is provided to users, but some information is overlooked by users. Thus, an alert is provided to users in some cases.

For example, as a first technique, there is a technique for displaying a list of unread information to clients in order to inhibit the unread information from being overlooked in a message board system (for example, Japanese Laid-open Patent Publication No. 2000-29798).

Regarding ICT, Japanese Laid-open Patent Publications Nos. 2007-226504, 2010-140454, and 2012-187178 have been disclosed.

In a case where a user uses a computer and performs a high-risk operation, a section for providing an alert in order to avoid a risk, making the user re-recognize that there is the risk, and promoting the user to reconfirm details of a task is relatively easily implemented and widely used.

FIG. 1 illustrates an example of a system configured to detect a high-risk operation performed by a user on a computer and provide an alert. In FIG. 1, when a high-risk operation is executed on a user's computer (hereinafter referred to as “PC”) 1, the PC 1 detects that the high-risk operation was performed and the PC 1 notifies a server 2 that the high-risk operation was performed.

Then, the server 2 provides a notification related to an alert to the PC 1 in order to avoid a risk. The PC 1 outputs the received notification to a display device. Then, the user confirms details (alert) of the notification displayed on the display device. Thus, the user may recognize the high-risk operation and pay attention in order to avoid a risk after the confirmation.

If such an alert is provided to the user many times, however, the user may lose attention to the alert and take the next action without firmly confirming the alert.

### SUMMARY

According to an aspect of the invention, an apparatus measures, based on an operation performed by a user on first alert information displayed on a display section of a terminal device, a confirmation time period taken for the user to confirm the first alert information, and outputs, based on the confirmation time period, to the terminal device, pseudo attack information to make or feign an attack against the terminal device, while outputting second alert information including information indicating a method of handling the attack to the terminal device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configured to detect a high-risk operation performed by a user on a computer, and provide an alert;

FIG. 2 is a diagram illustrating an example of an alert handling supporting device, according to an embodiment;

FIG. 3 is a diagram illustrating an example of an information communication system, according to an embodiment;

FIG. 4 is a diagram illustrating an example of an operational sequence between a PC and a server in a case where alert information is not ignored, according to an embodiment;

FIG. 5 is a diagram illustrating an example of an operational sequence between a PC and a server in a case where the alert information is ignored, according to an embodiment;

FIG. 6 is a diagram illustrating an example of a pseudo attack mail and an alert screen, according to an embodiment;

FIG. 7 is a diagram illustrating an example of an operational sequence between a PC and a server in a case where an option A is applied, according to an embodiment;

FIG. 8 is a diagram illustrating an example of a user characteristic DB, according to an embodiment;

FIG. 9 is a diagram illustrating an example of an operational sequence in a case where an option A1 is applied, according to an embodiment;

FIG. 10 is a diagram illustrating an example of an operational sequence in a case where an option A2 is applied, according to an embodiment;

FIG. 11 is a diagram illustrating an example of a screen display, according to an embodiment;

FIG. 12 is a diagram illustrating an example of a screen display upon an increase in a level, according to an embodiment;

FIG. 13 is a diagram illustrating an example of an operational sequence in a case where an option B1 is applied, according to an embodiment;

FIG. 14 is a diagram illustrating an example of a user management DB, according to an embodiment;

FIG. 15A is a diagram illustrating an example of a screen display, according to an embodiment;

FIG. 15B is a diagram illustrating an example of a screen display, according to an embodiment;

FIG. 15C is a diagram illustrating an example of a screen display, according to an embodiment;

FIG. 16 is a diagram illustrating an example of an operational flowchart for a whole process, according to an embodiment;

FIG. 17 is a diagram illustrating an example of an operational flowchart for a process to be used in a case where option A1 is applied, according to an embodiment;

FIG. 18 is a diagram illustrating an example of an operational flowchart for a process to be used in a case where option A2 is applied, according to an embodiment;

FIG. 19 is a diagram illustrating an example of an operational flowchart for a process to be used in a case where option B1 or B2 is applied, according to an embodiment;

FIG. 20 is a diagram illustrating an example of an operational flowchart for a process to be used in a case where option B1 is applied, according to an embodiment;

FIG. 21 is a diagram illustrating an example of an operational flowchart for a process to be used in a case where option B1 is applied, according to an embodiment;

FIG. 22 is a diagram illustrating an example of an operational flowchart for a process to be used in a case where option B1 is applied, according to an embodiment;

FIG. 23 is a diagram illustrating an example of an operational flowchart for a process to be used in a case where option B2 is applied, according to an embodiment; and

FIG. 24 is a diagram illustrating an example of a hardware configuration of a computer configured to execute a program, according to an embodiment.

### DESCRIPTION OF EMBODIMENT

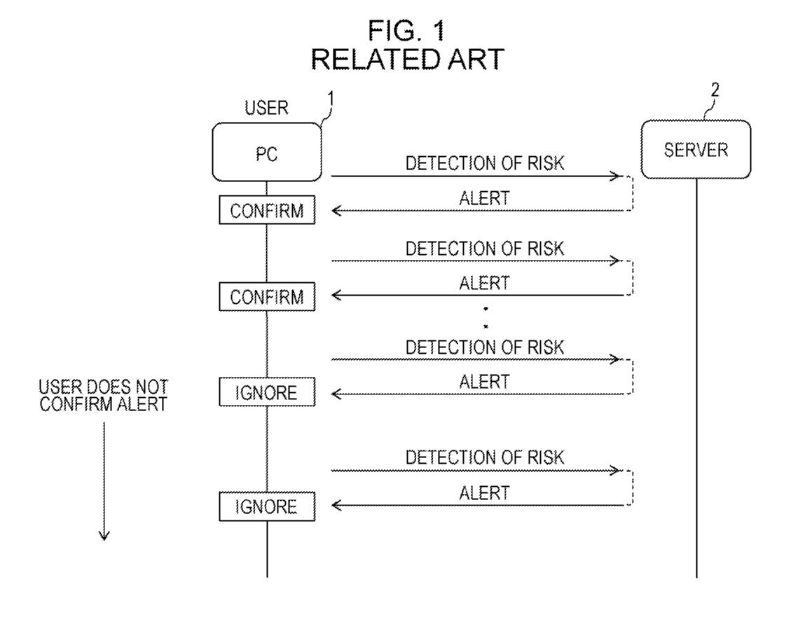

As illustrated in FIG. 1, the user confirms alerts notified from the server for the initial period of time, but becomes less aware of risks with time and does not confirm and ignores alerts notified from the server. As techniques for avoiding this, the following techniques are considered.

(1) After an alert is provided upon a computer operation performed by the user and the user confirms the alert, the user is caused to press a confirmation button. In this case, before a whole sentence of the alert is displayed, the confirmation button is not displayed (terms of service, conditions of contract, and the like).

(2) A whole screen of the computer is grayed out and only a window for the alert is set to be active.

(3) When the user reads the sentence of the alert to the last, a point is provided to the user (a mail magazine and the like).

In the aforementioned examples (1) and (2), however, if the button and the screen are frequently displayed, the user may close the alert by reflectively performing an operation. In the aforementioned example (3), only a temporal effect is obtained by providing the point in some cases.

It is preferable to inhibit a user from ignoring an alert against the delivery of malicious information.

A method of providing incentives such as points to users is “extrinsic motivation” in psychology, and it is considered that only a temporal effect is obtained by the method. The extrinsic motivation is motivation aroused by stimuli outside individuals and is based on evaluation of performance, rewards, praise, penalties, and the like.

In an embodiment, a continuous effect is produced by arousing “spontaneous motivation” in psychology. The spontaneous motivation is aroused from the inside of individuals and is based on self-determination, self-control, self-efficacy, intellectual curiosity, sense of acceptance from others, and the like.

In the embodiment, a successful experience is given to a user at certain time intervals in order to arouse spontaneous motivation to confirm an alert. Specifically, an experience in avoiding a mistake, an accident, or the like by confirming a mail or the like in accordance with an alert is intentionally given to the user. In the embodiment, an experience in which a user found a targeted attack mail is treated as a successful experience. The successful experience improves the effect when the user selects an appropriate experience that will be recognized to be successful by the user.

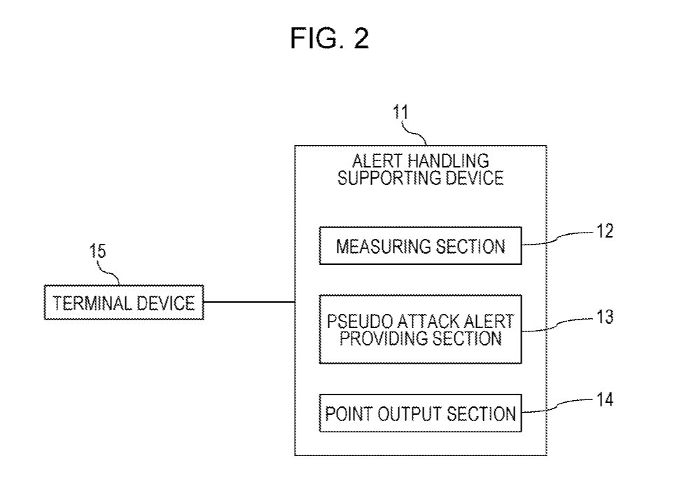

FIG. 2 illustrates an example of an alert handling supporting device according to the embodiment. An alert handling supporting device 11 includes a measuring section 12 and a pseudo attack alert providing section 13.

The measuring section 12 measures, based on an operation performed by a user for first alert information displayed on a terminal device 15, a period of time taken for the user to confirm a mail or the like for the first alert information. An example of the measuring section 12 is a skipping detector 35.

The pseudo attack alert providing section 13 executes a process of making or feigning an attack on the terminal device, based on the confirmation time period and outputs second alert information including information indicating a method of handling the attack. Examples of the pseudo attack alert providing section 13 include an alert transmitter 33 and a pseudo attack mail transmitter 34.

Since the alert handling supporting device 11 is configured as described above, the alert handling supporting device 11 may inhibit the user from ignoring an alert against the delivery of malicious information. Specifically, the alert handling supporting device 11 may promote the user to handle the alert against the delivery of the malicious information. Thus, every time an alert against the delivery of malicious information is provided, the user handles the alert. As a result, the user may gain the habit of continuously handling alerts against the delivery of malicious information, and the alert handling supporting device 11 may inhibit the user from ignoring such alerts.

It is assumed that the confirmation time period is a time period from the time when a screen indicating alert information is displayed or is visually recognized by the user to the time when the screen is closed. In this case, when the confirmation time period is not in a predetermined time range or is longer than a predetermined time, the pseudo attack alert providing section 13 outputs pseudo attack information and the second alert information to the terminal device 15.

Since the alert handling supporting device 11 is configured as described above, the alert handling supporting device 11 may determine whether or not the user confirmed alert information.

The alert handling supporting device 11 further includes a point output section 14. The point output section 14 provides points to users based on whether or not the second alert information having, added thereto, a point weighted based on the degree of importance was handled, a time period for the handling, and whether or not the users were trapped by the pseudo attack information. The point output section 14 outputs the provided points to the terminal device 15. An example of the point output section 14 is a point setting section 36.

Since the alert handling supporting device 11 is configured as described above, the alert handling supporting device 11 enables users to confirm the states of attack handling by the users.

The point output section 14 calculates the points for groups of the users and outputs, to the terminal device, a graph in which the groups are ranked based on the calculated numbers of the points. Since the alert handling supporting device 11 is configured as described above, the states of the attack handling by the users may be visually recognized.

The point output section 14 adjusts, based on the points, a frequency at which alert information is notified. Since the alert handling supporting device 11 is configured as described above, a method of providing an alert based on users' levels may be presented.

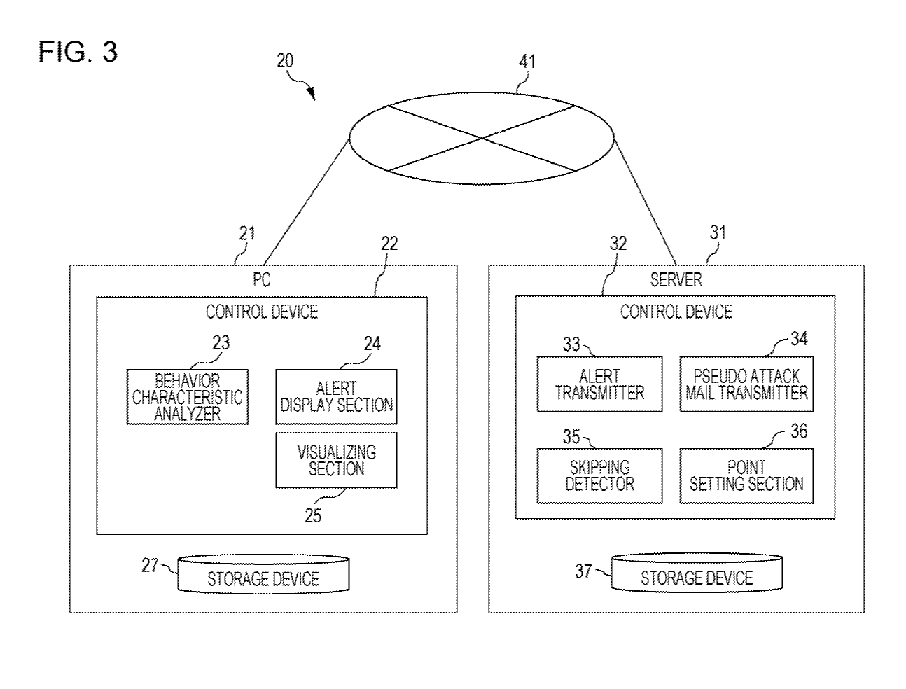

FIG. 3 illustrates an example of an information communication system according to the embodiment. An information communication system 20 includes a PC 21, a server 31, and a network 41. The network 41 is a communication network that connects the PC 21 and the server 31 to each other and enables the PC 21 and the server 31 to communicate with each other. For example, the network 41 is the Internet, a local area network (LAN), or the like.

The PC 21 is an information processing terminal to be used by a user and includes a control device 22, a storage device 27, an output device (not illustrated), and an input device (not illustrated). The output device is a display device or the like. The input device is a mouse device or the like. The control device 22 controls operations of the whole PC 21. The storage device 27 has, stored therein, an operating system (OS), application software, user data, a program according to the embodiment, data to be used for the program, and the like. Anti-attack software may be installed in the PC 21.

The control device 22 reads the program according to the embodiment from the storage device 27, executes the read program, and thereby functions as a behavior characteristic analyzer 23, an alert display section 24, and a visualizing section 25.

The behavior characteristic analyzer 23 analyzes behavior characteristics of the user from operations performed by the user on the PC 21 and detects a risk to the operations by the user.

The alert display section 24 outputs alert information notified from the server 31 to the display device. In a case where anti-attack and antivirus software is installed in the PC 21, a display function to be used when the anti-attack and antivirus software executes virus detection may be used as the alert display section 24. In a case where a mail system to be used in the embodiment is a web mail system, and the anti-attack and antivirus software is installed in the web mail system, the display function to be used when the anti-attack and antivirus software executes the virus detection may be used as the alert display section 24.

The visualizing section 25 visualizes the state of the attack handling by the user (for example, converts the state of the attack handling into a graph) based on information calculated by the point setting section 36 described later.

The server 31 includes a control device 32 and a storage device 37. The control device 32 controls operations of the whole server 31. The storage device 37 has, stored therein, an operating system (OS), application software, user data, the program according to the embodiment, data to be used for the program, and the like.

The control device 32 reads the program according to the embodiment from the storage device 37, executes the read program, and functions as the alert transmitter 33, the pseudo attack mail transmitter 34, the skipping detector 35, and the point setting section 36.

The skipping detector 35 determines whether or not the user has skipped or left the alert information, based on alert information, for example, by determining whether or not the user has closed a screen indicating the alert information, which was displayed on the display device.

When the skipping detector 35 determines that the user has skipped or left the alert information, the pseudo attack mail transmitter 34 makes an attack on the PC 21. For example, the pseudo attack mail transmitter 34 transmits a pseudo attack mail to the PC 21. The pseudo attack mail is a virtual pseudo attack mail generated by the server. The embodiment assumes that the pseudo attack mail is a targeted attack mail as an example, but is not limited to this. For example, the pseudo attack mail may be an attack mail against which the PC 21 is able to be protected in accordance with an alert described later. Alternatively, the pseudo attack mail may be a mail that feigns an attack although the attack is not actually made.

The pseudo attack mail transmitter 34 may transmit the pseudo attack mail to the PC 21, based on predetermined timing (for example, at certain time intervals).

The alert transmitter 33 transmits alert information to the PC 21, based on predetermined timing or a notification indicating risk detection, which is received from the PC 21. In addition, when the skipping detector 35 determines whether or not the user skipped or left the alert information, the alert transmitter 33 transmits the alert information while the pseudo attack mail transmitter 34 transmits the pseudo attack mail.

The point setting section 36 converts the state of the attack handling performed on pseudo attack mails from the server within a predetermined time period, into points, and calculates the state of the attack handling by the user, based on the accumulated points.

The mail system to be used in the embodiment may be a web mail system, or mail software may be installed in the PC 21. When the mail system to be used in the embodiment is a web mail system, a process (described below) to be executed on the side of the PC 21 corresponds to a process to be executed on a web browser displayed on the PC 21. In this case, the actual process is executed by the server 31.

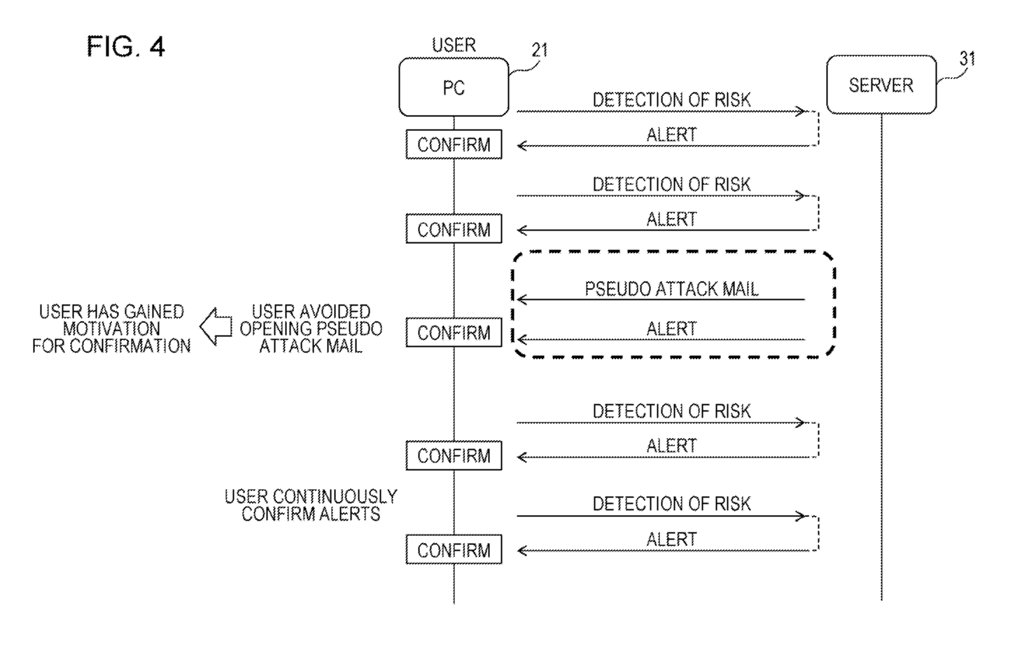

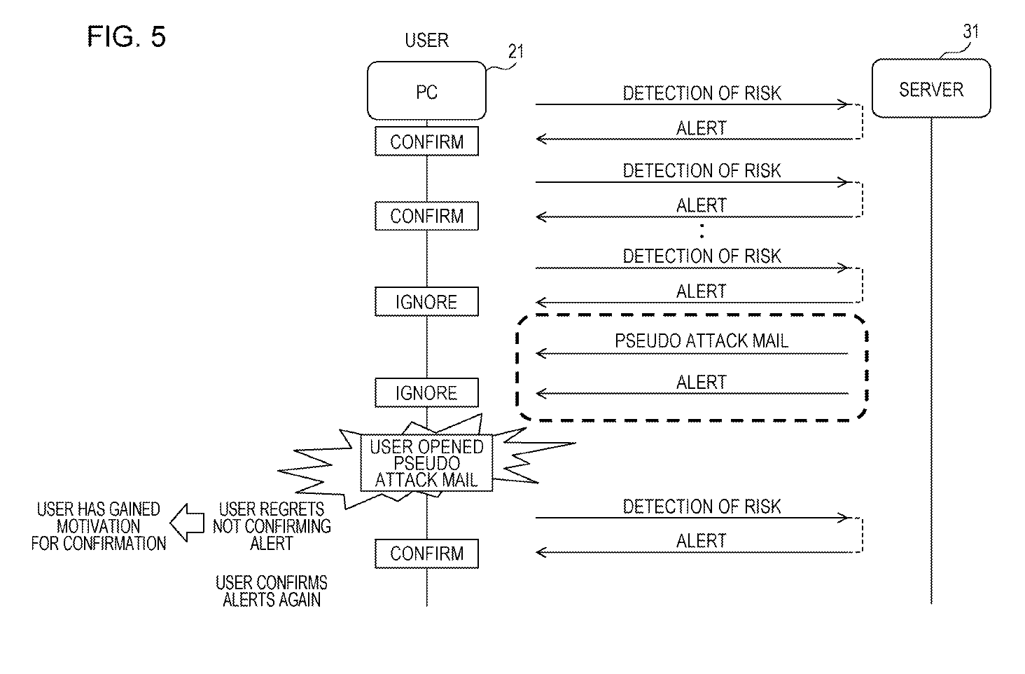

FIG. 4 illustrates an operational sequence between the PC and the server in a case where the embodiment is applied (in a case where alert information is not ignored). FIG. 5 illustrates an operational sequence between the PC and the server in the case where the embodiment is applied (in a case where alert information is ignored).

In FIG. 4, when a high-risk operation is performed by the user, the behavior characteristic analyzer 23 detects that the high-risk operation was performed, and the behavior characteristic analyzer 23 notifies the server 31 that the high-risk operation was performed.

Then, the server 31 (alert transmitter 33) transmits alert information to the PC 21 in order to avoid a risk.

The PC 21 (alert display section 24) outputs the received alert information to the display device. Every time alert information is displayed on the display device, the user may visually recognize details of a screen (alert screen) related to the alert information displayed on the display device. When the user has recognized details of an alert, the user presses a confirmation button provided on the alert screen to complete the confirmation of the alert information.

The server 31 transmits a pseudo attack mail and alert information to the PC 21 at certain times (for example, at certain time intervals). The PC 21 receives the pseudo attack mail and displays the pseudo attack mail on the display device. In this case, as the pseudo attack mail, a content that avoids an attack if an operation is performed in accordance with the alert is transmitted.

It is assumed that the user has avoided opening the pseudo attack mail in accordance with the alert information. Then, it is considered that the user will be motivated by this successful experience and continue to confirm an alert notified from the server 31.

On the other hand, in FIG. 5, it is assumed that the user has not confirmed the alert information and opened the pseudo attack mail. In this case, the user may regret not confirming the alert information, and this failed experience may give motivation to continue to confirm alert information to the user. As a result, the user may confirm alert information again.

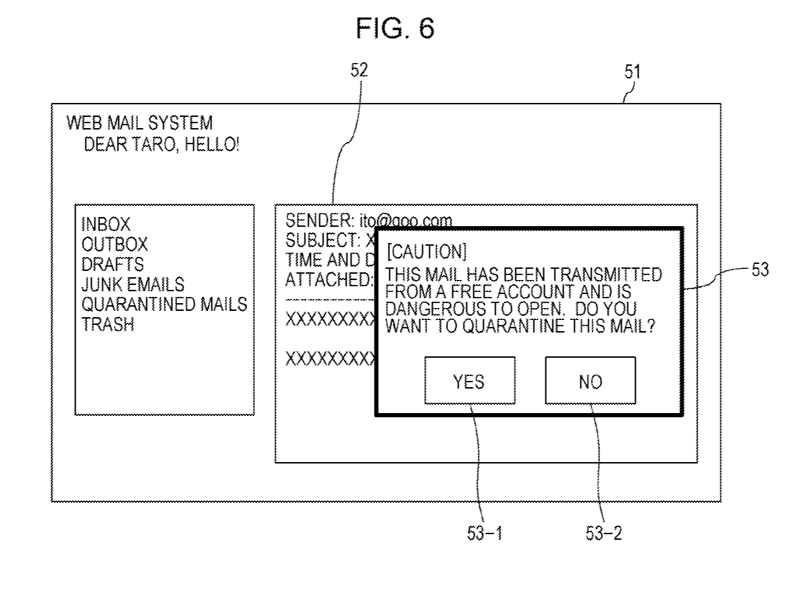

FIG. 6 illustrates an example of the pseudo attack mail and the alert screen according to the embodiment. It is assumed that a home screen 51 of the mail system is displayed on the display device of the PC 21. On the home screen 51, a pseudo attack mail 52 is displayed.

In addition, an alert screen 53 indicating alert information is displayed by the alert display section 24. As an example, the alert screen 53 includes a “yes” button 53-1 for agreeing an alert and a “no” button 53-2 for disagreeing the alert.

In the embodiment, the effect may be further improved by adding the following options.

Example 1, Option A

In the above description, the successful experience is given at certain time periods, regardless of the state of the user. The successful experience may be given to the user, based on behavior characteristics of the user. For example, when the server 31 recognizes, based on the behavior characteristics of the user, that the user has a tendency to ignore an alert, effective motivation may be given to the user by giving the successful experience to the user. For example, the behavior characteristics of the user may be determined based on the detection of user's tendencies, such as times elapsing until clicking, the number of times an alert is displayed, mouse operations by the user, and the direction of the eyes of the user.

In an option A, when alert information is displayed, a method of determining, based on a time period for which the alert information is displayed, whether or not the user properly recognized details of the alert information is presented. As illustrated in FIG. 6, when the alert information is displayed on the alert screen 53, a time period for recognizing the details of a message displayed on the alert screen 53 is beforehand set in the server 31. When a time period from the time when the alert screen 53 is displayed to a time when the alert screen 53 is closed is shorter than the time period beforehand set in the server 31, the server 31 recognizes that the user has a tendency to ignore an alert. Thus, a pseudo alert is provided in order to give the successful experience.

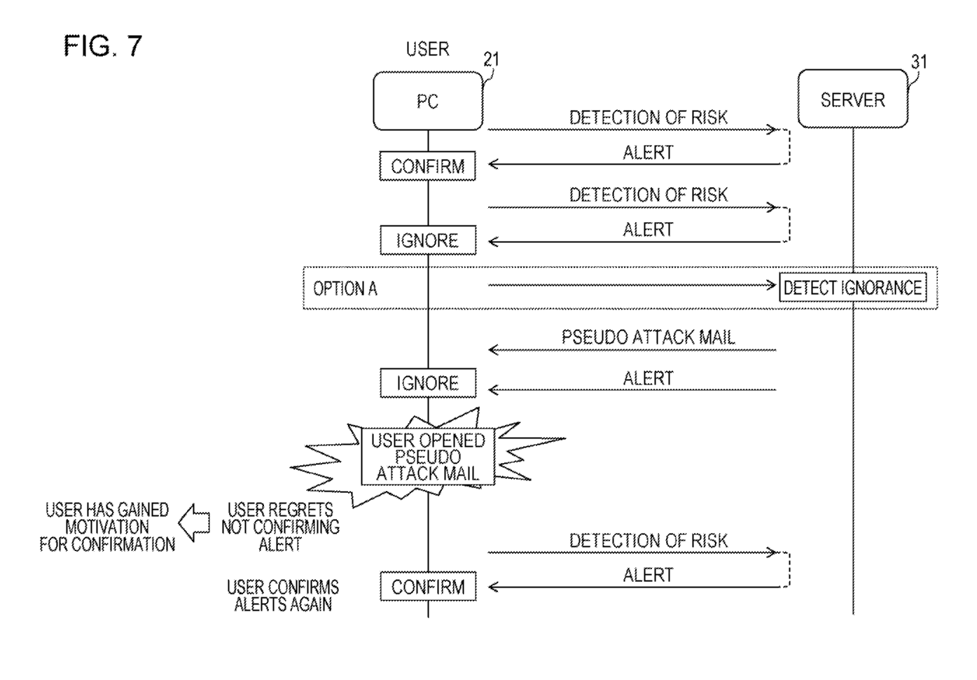

FIG. 7 illustrates an operational sequence between the PC and the server in a case where the option A according to Example 1 of the embodiment is applied. In FIG. 7, for example, it is assumed that the user has closed the alert screen 53 without confirming details of the alert screen 53. The PC 21 notifies the server 31 that the alert screen 53 was closed.

The server 31 (skipping detector 35) determines, based on the notification received from the PC 21, whether or not the user confirmed the alert information. When the server 31 (skipping detector 35) determines that the user has not confirmed the alert information, the server 31 (alert transmitter 33 and pseudo attack mail transmitter 34) transmits a pseudo attack mail and alert information to the PC 21.

When receiving the pseudo attack mail and the alert information, the PC 21 (alert display section 24) displays the received pseudo attack mail and the received alert information on the display device. It is assumed that the user did not confirm the alert information and has opened the pseudo attack mail. The user may regret not confirming the alert information, and this failed experience may give motivation to confirm alert information to the user after the failed experience. As a result, the user may confirm alert information again.

Variations of the option A are described below.

Example 1-1, Option A1

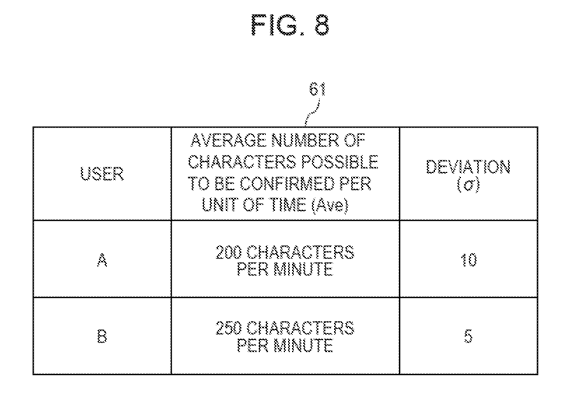

FIG. 8 illustrates an example of a user characteristic database according to Example 1-1 of the embodiment. The storage device 37 of the server 31 has, stored therein, a user characteristic database (DB) 61. The user characteristic DB 61 stores, for each user, an average Ave indicating the average number of characters possible to be confirmed per unit of time by each user and a deviation 6 from the average Ave.

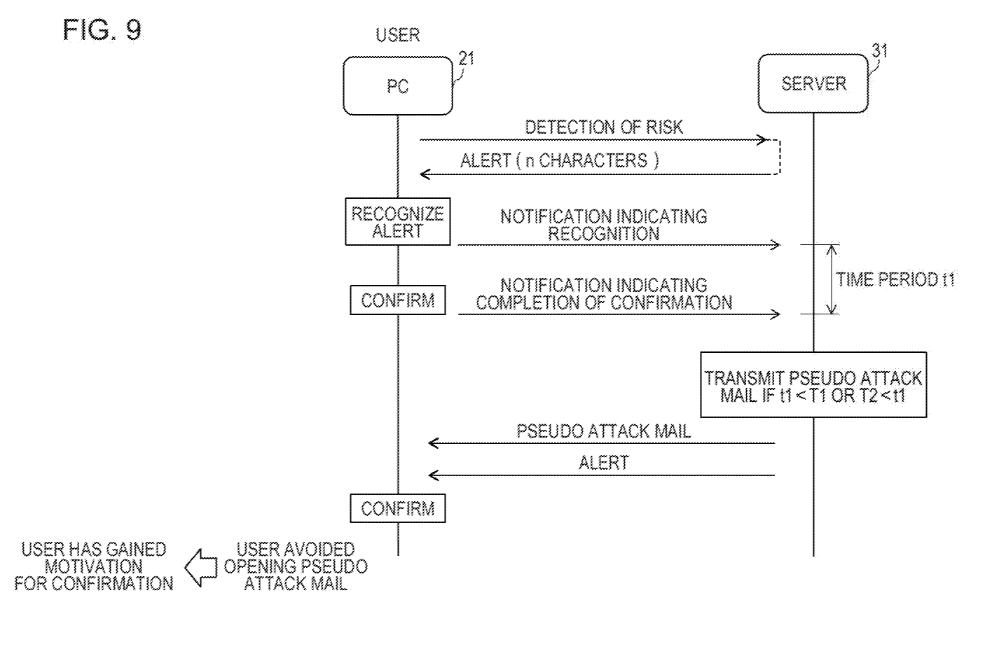

FIG. 9 is an operational sequence for a process flow in a case where an option A1 according to Example 1-1 of the embodiment is applied.

Upon receiving, from the PC 21, a notification indicating that the user recognized alert information, the server 31 (skipping detector 35) measures a time period for confirming the alert. It is assumed that the time period for confirming the alert is a time period from a time when the user recognizes the alert to a time when the user confirms the alert (for example, a time when the alert screen is closed). For example, the recognition of the alert indicates that at least any of the following conditions is satisfied: a condition that a trajectory of a mouse operation by the user matches or is similar to a predetermined pattern, a condition that “the direction of the eyes” of the user that is monitored by a web camera is a predetermined direction, and a condition that the alert screen is opened.

When the server 31 (skipping detector 35) determines that the time period for confirming the alert is too short or too long, the server 31 (skipping detector 35) determines that the user has ignored the alert information, and the server 31 (skipping detector 35) transmits a pseudo attack mail.

For example, when the user who is logging in and using the PC 21 is a user A, the skipping detector 35 acquires records associated with the user A from the user characteristic DB 61. The skipping detector 35 acquires, from the records, 200 characters per minute as the number (average) of characters possible to be confirmed per unit of time and 10 as a deviation (a).

When a high-risk operation is performed by the user A, the PC 21 (behavior characteristic analyzer 23) detects that the high-risk operation has been performed, and the PC 21 (behavior characteristic analyzer 23) notifies the server 31 that the high-risk operation has been performed. Then, the server 31 (alert transmitter 33) transmits alert information to the PC 21 in order to avoid a risk.

The PC 21 (alert display section 24) outputs the received alert information to the display device. When receiving, from the PC 21, a notification indicating that the user has recognized the alert information, the server 31 (skipping detector 35) starts to measure a confirmation time period t1 for confirming the alert.

It is assumed that the user has closed the displayed alert screen by using a mouse or the like. The PC 21 notifies the server 31 of a confirmation completion notification indicating that the alert screen has been closed. When receiving the confirmation completion notification, the server 31 (skipping detector 35) terminates the measurement of the confirmation time period t1.

The skipping detector 35 calculates T1=n/(Ave−2σ) and T2=n/(Ave+2σ), where n is the number of characters included in the alert. A range of (Ave±2σ) corresponds to approximately 95% of the whole distribution.

The skipping detector 35 determines, based on t1 notified from the PC 21 and the calculated T1 and T2, whether the user has skipped the alert information (the number n of characters) displayed on the alert screen or has left the alert information without closing the alert screen.

Specifically, when t1<T1, the skipping detector 35 determines that the user has skipped the alert information. When T2<t1, the skipping detector 35 determines that the user has left the alert information.

The case where the alert information has been left includes a case where the user has received a phone call by chance, a case where the user has been called by another person, and a case where the user has intentionally ignored the alert information. Thus, it is preferable that information indicating that the user has not intentionally ignored the alert information be fed back to the PC 21 or the server 31.

When t1<T1 or T2<t1, the pseudo attack mail transmitter 34 transmits a pseudo attack mail to the PC 21 and the alert transmitter 33 transmits alert information to the PC 21.

Upon receiving the pseudo attack mail and the alert information, the PC 21 (alert display section 24) displays the received pseudo attack mail and the received alert information on the display device. As the pseudo attack mail to be received, a content that is avoidable if an operation is performed in accordance with the alert may be transmitted.

It is assumed that the user has avoided opening the pseudo attack mail in accordance with the alert information. It is considered that the user will be motivated by this successful experience and continue to confirm an alert notified from the server 31.

In the above description, T1=n/(Ave−2σ) is used as a threshold for the detection of the skipping of the alert information, but is not limited to this. For example, the minimum period of time for the user to recognize and confirm the alert information may be set in the server 31, based on contents of the alert screen and the amount of the contents of the alert screen.

In the above description, the calculation of T1 and T2 and the determination of whether or not the user has skipped or left the alert information are executed by the server 31, but are not limited to this and may be executed by the PC 21. In this case, when the PC 21 detects that the user has skipped or left the alert information, the PC 21 notifies the server 31 that the user has skipped or left the alert information. Upon receiving the notification, the server 31 may transmit a pseudo attack mail and alert information to the PC 21.

Example 1-2, Option A2

In Example 1-2, an alert is provided to the user, by continuously displaying the alert based on the detection of a risk, making only a window of the alert active, or the like. The skipping detector 35 detects the state of the user's visual recognition of the alert, based on a mouse operation by the user and the direction of the eyes of the user. When an operation of confirming details of an alert is not performed within a certain time period from a time when the state of the visual recognition is detected, the server 31 may recognize that the user has a tendency to ignore an alert, and spontaneous motivation may be efficiently given to the user.

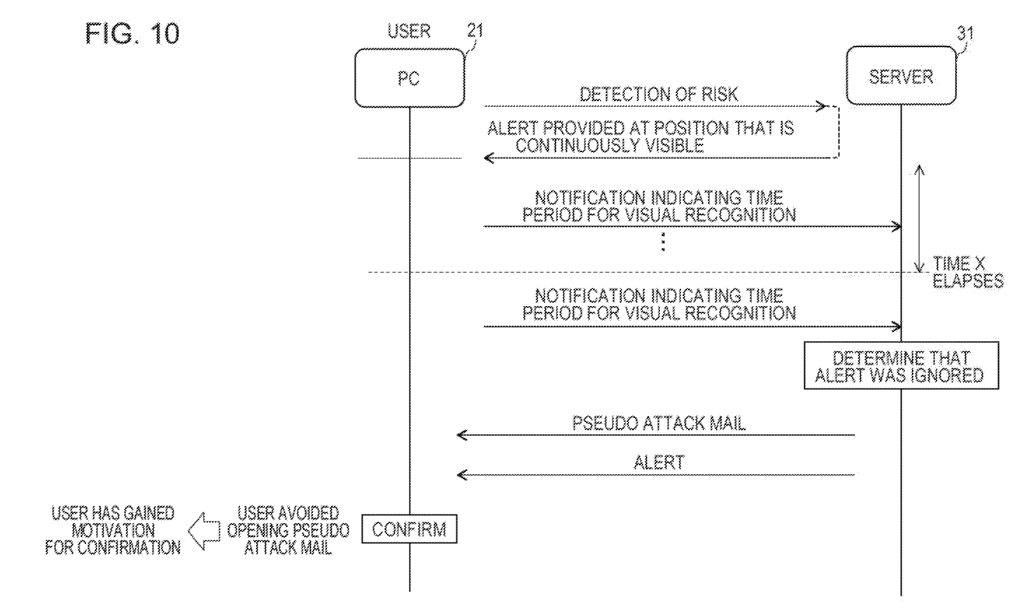

FIG. 10 is a diagram describing a process flow in a case where an option A2 according to Example 1-2 of the embodiment is applied.

When a high-risk operation is performed by the user A, the PC 21 (behavior characteristic analyzer 23) detects that the high-risk operation has been performed, and the PC 21 (behavior characteristic analyzer 23) notifies the server 31 that the high-risk operation has been performed. Then, the alert transmitter 33 of the server 31 transmits alert information to the PC 21 in order to avoid a risk. In this case, the alert display section 24 displays the alert on the display device at a position that is continuously visible.

The skipping detector 35 determines whether or not the user visually recognized the alert information, based on a user's mouse operation, “the direction of the eyes” of the user, the positions of the pupils of the user, or the like, which are monitored by the PC 21. When the skipping detector 35 determines, based on the user's mouse operation, the “the direction of the eyes” of the user, the positions of the pupils of the user, or the like, that the user has visually recognized the alert information, the skipping detector 35 starts to measure a time period t2. Upon determining that the user has completed the confirmation of the alert, the skipping detector 35 terminates the measurement of the time period t2.

The skipping detector 35 compares a predetermined time X with the time period t2 that is being measured until the user completes the confirmation of the alert. When the time period t2 that is being measured becomes longer than the predetermined time X, the skipping detector 35 determines that the operation of confirming the details of the alert has not been performed, or the skipping detector 35 determines that the alert has been ignored.

When the skipping detector 35 determines that the operation of confirming the details of the alert has not been performed, the pseudo attack mail transmitter 34 transmits a pseudo attack mail to the PC 21, and the alert transmitter 33 transmits alert information to the PC 21.

The PC 21 (alert display section 24) receives the pseudo attack mail and the alert information, and displays the received pseudo attack mail and the received alert information on the display device. As the pseudo attack mail to be received, a content that is avoidable if the operation is performed in accordance with the alert may be transmitted.

In the above description, the determination of whether or not the operation of confirming the details of the alert has been performed is made by the server 31 based on the comparison of t2 with the predetermined time X, but is not limited to this and may be made by the PC 21 based on the comparison of t2 with the predetermined time X. In this case, when the time period t2 becomes longer than the predetermined time X, and the PC 21 determines that the operation of confirming the details of the alert has not been performed, the PC 21 may notify the server 31 that the operation of confirming the details of the alert has not been performed. Upon receiving the notification, the server 31 may transmit a pseudo attack mail and alert information to the PC 21.

It is assumed that the user has avoided opening the pseudo attack mail in accordance with the alert information. In the case, it is considered that the user will be motivated by this successful experience and thereafter continue to confirm an alert notified from the server 31.

Example 2, Option B

Example 2 describes, as an option B, a case where a successful experience in avoiding the opening of a pseudo attack mail is visualized and spontaneous motivation is improved. An example of the visualization is described below.

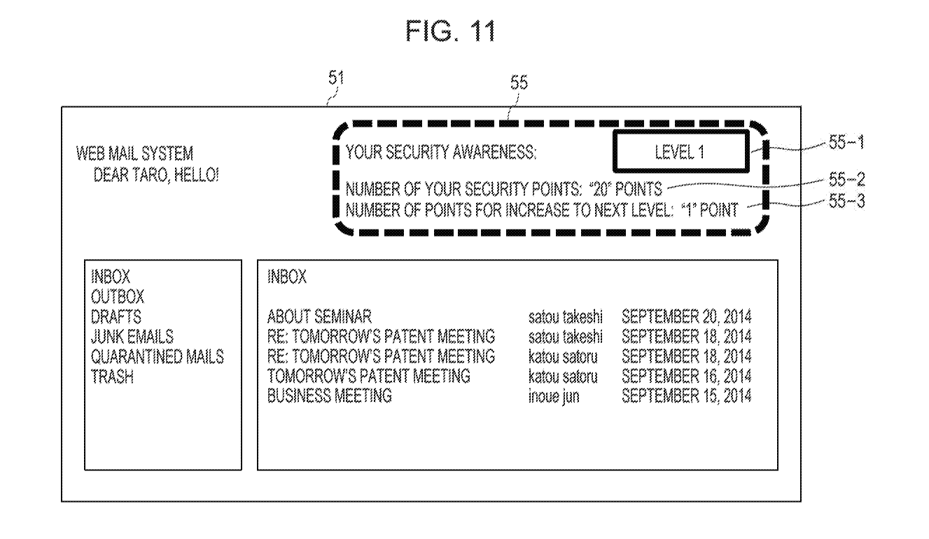

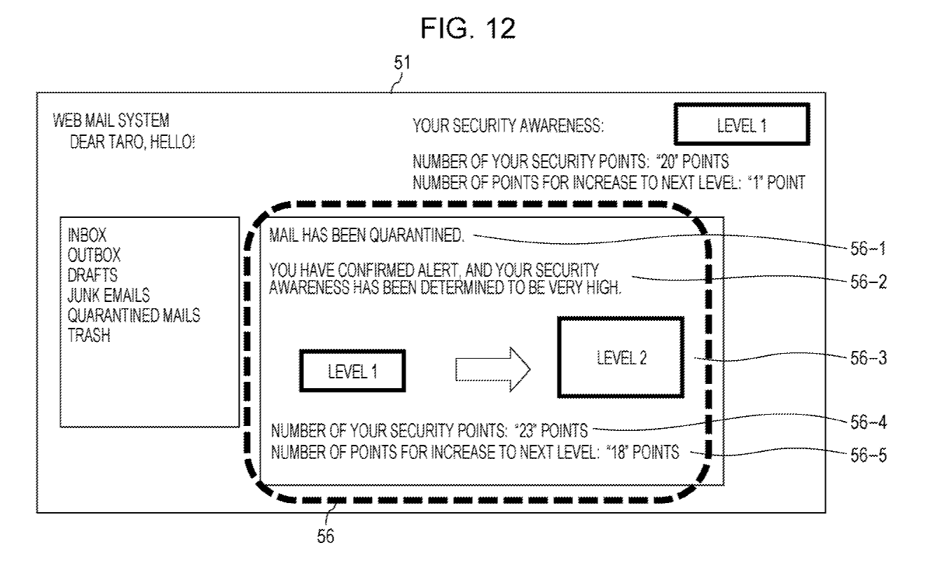

FIGS. 11 and 12 illustrate examples that are common to the option B and in which a successful experience in avoiding the opening of a pseudo attack mail is visualized for each user.

FIG. 11 illustrates an example of a screen display according to Example 2 of the embodiment. The visualizing section 25 displays the following items in a region 55 (surrounded by a broken line) of the home screen 51 of the mail software, for example. Specifically, the visualizing section 25 displays, in the region 55 (surrounded by the broken line), 55-1 indicating the level of security awareness of the user, 55-2 indicating current security points of the user, and 55-3 indicating security points for an increase to the next level.

FIG. 12 illustrates an example of the screen display upon an increase in the level in Example 2 of the embodiment. When the user avoids opening a pseudo attack mail by properly confirming an alert, and the number of the security points of the user has reached the number of security points required for increasing the user's level to the next level, the visualizing section 25 executes the following process. Specifically, the visualizing section 25 notifies the home screen 51 of details of the increase in the level, as indicated by a region 56 surrounded by a broken line in FIG. 12. In the region 56, the content 56-1 of the handling performed on the pseudo attack mail, the content 56-2 of the evaluation of the increase in the level, and levels 56-3 before and after the increase in the level are displayed. In addition, in the region 56, the number 56-4 of current security points of the user and the number 56-5 of points required for increase to the next level are displayed.

Variations of Example 2 (option B) are described below.

Example 2-1, Option B1: Visualization Based on Ranks

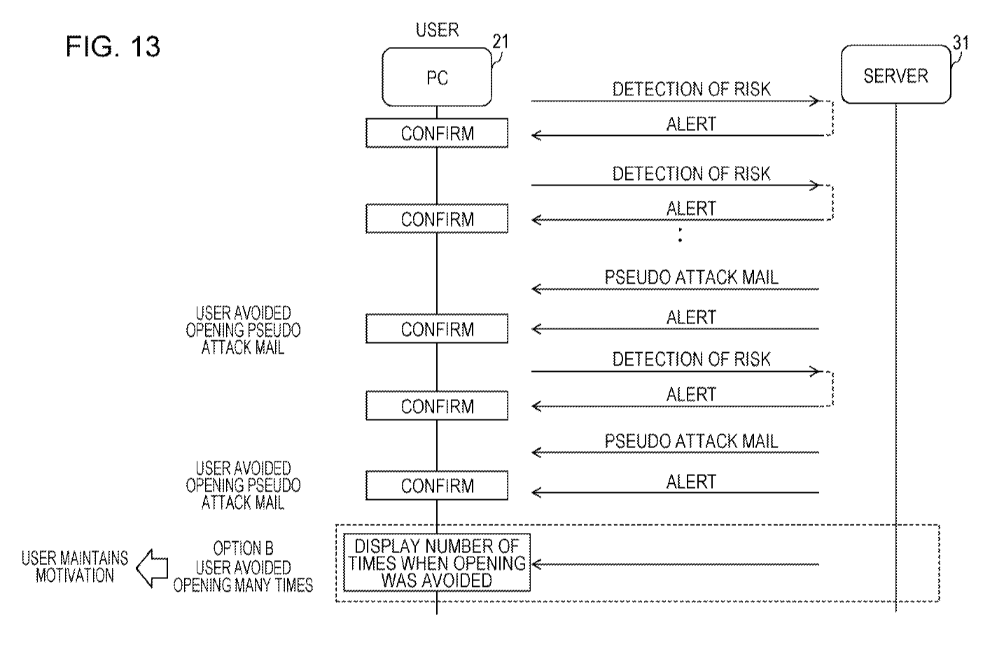

FIG. 13 is a diagram describing a process flow in a case where an option B1 according to Example 2-1 of the embodiment is applied. The number of times the opening of a pseudo attack mail is avoided is calculated as the number of security points by the server 31. In order to calculate the number of security points, the server 31 calculates the number of times the opening of a pseudo attack mail is avoided.

It is assumed that the option A according to Example 1 is applied and that the user avoided opening a pseudo attack mail a certain number of times. After that, the visualizing section 25 displays, on the screen, the number of times the opening of a pseudo attack mail has been avoided, based on an instruction from the user or an instruction from the server 31.

Thus, the user may visually recognize the number of successful experiences in avoiding the opening of a pseudo attack mail in accordance with alert information. It is considered that the user will be motivated by the visualized successful experiences and continue to confirm an alert notified from the server 31 after the successful experiences.

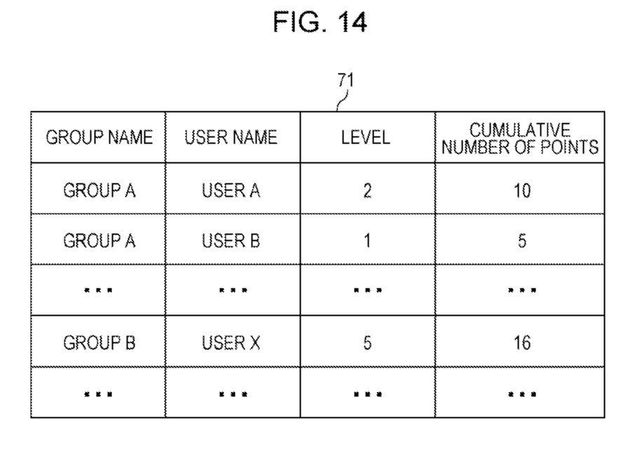

FIG. 14 illustrates an example of a user management DB according to Example 2 of the embodiment. In the option B1 according to Example 2-1, motivation to avoid the opening of a pseudo attack mail may be improved by forming groups of users and making the groups compete with each other for higher ranks based on points.

A user management DB 71 is stored in the storage device 37 of the server 31. The user management DB 71 includes data items for “group name”, “user name”, “level”, and “cumulative number of points”. In the “group name” item, the name of a group to which a user belongs is stored. In the “user name” item, the name of the user is stored. In the “level” item, the level of the user which is determined based on the cumulative number of points is stored. In the “cumulative number of points” item, the cumulative number of points, which is acquired by the user based on the states of the user that has handled pseudo attack mails the certain number of times, is stored.

Variations of a screen for visually displaying the number of successful experiences in avoiding the opening of a pseudo attack mail are described below.

In Example 2-1, the states of the attack handling performed within a predetermined time period are converted into points. For example, the states are ranked for the user groups and converted into the points which are visually recognizable. Thus, users' motivation to confirm alerts is maintained and improved by displaying the rates of changes in ranks from past ranks.

It is assumed that the server 31 manages priorities (of three types, a high or Hi priority, a middle or Mid priority, and a low or Lo priority) of alerts. In addition, it is assumed that the number of all the alerts is 10 (for example, one alert of the Hi priority, three alerts of the Mid priority, and six alerts of the Lo priority).

Points are described as follows:

When an alert of the Hi priority is handled, 1 point is added;

When an alert of the Mid priority is handled, 2 points are added;

When an alert of the Lo priority is handled, 3 points are added;

When a time taken to start handling the alert is long, 1 point is added;

When a time taken to start handling the alert is middle, 2 points are added;

When a time taken to start handling the alert is short, 3 points are added;

When the alert is not handled, a point is not added; and

8) When a pseudo attack mail is opened, 20 points are subtracted (a user's level is reduced by 1. When the level is a level 1, the cumulative number of points is set at 0).

Upon receiving, from the PC 21, the result of handling an alert by the user, the server 31 calculates the number of points, based on the priority of the alert, a time period for handling the alert, and whether or not a pseudo attack mail was opened. The server 31 adds the calculated number of points to the “cumulative number of points” of the user management DB 71.

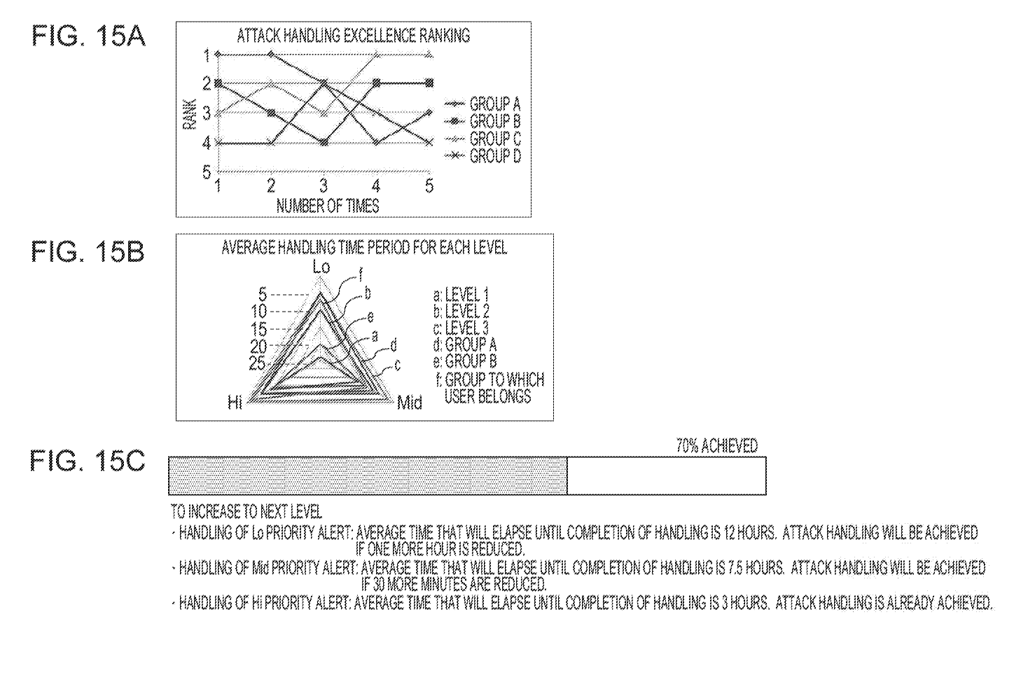

When an instruction to display ranks for the user groups is provided from the user, the visualizing section 25 acquires information stored in the user management DB 71 from the server 31. The visualizing section 25 displays a graph shown in FIG. 15A, based on the acquired information stored in the user management DB 71.

FIGS. 15A, 15B, and 15C illustrate examples of the screen display according to Example 2 of the embodiment. FIG. 15A illustrates an example of the screen display in the case where the option B1 according to Example 2-1 of the embodiment is applied. As illustrated in FIG. 15A, the visualizing section 25 calculates the number of points acquired within a predetermined calculation time period for each of the groups and gives ranks to the groups so that as a group has a larger number of points, a higher rank is given to the group. The visualizing section 25 displays the ranks of the groups. In FIG. 15A, the ranks of the groups for past 5 calculation time periods are displayed.

Example 2-2, Option B2: Provision of Levels as Degree of Excellence of Attack Handling

In Example 2-2, a method of visualizing the states of the attack handling and a method of providing alerts based on levels are presented. Thus, it is possible to visualize the rates of achieving the attack handling and promote users to follow the alerts based on the levels.

FIG. 15B illustrates an example of the screen display in a case where an option B2 according to Example 2-2 of the embodiment is applied. In

FIG. 15B, the average of time periods taken to handle an alert based on the priorities for each of the levels, and the average of time periods taken to handle an alert based on the priorities for each of the groups, are shown in a graph.

Next, the method of providing an alert based on each of the levels is described. It is assumed that the priorities (of three types, Hi, Mid, and Lo) are provided for alerts, for example. In addition, it is assumed that the number of all the alerts is 10 (one alert of the Hi priority, three alerts of the Mid priority, and six alerts of the Lo priority), for example. Furthermore, the levels are provided based on the handling that is performed by the users upon the occurrence of the alerts described on the assumption above.

A user of the level 1 is a user who does not handle alerts much or is considered to be slow to handle an alert and whose cumulative number of points is in a range between 0 to 20. A user of a level 2 is a user who more frequently handles alerts than the user of the level 1 and whose cumulative number of points is in a range between 21 and 40. A user of a level 3 is a user who handles alerts and whose cumulative number of points is in a range between 41 and 55.

As the method of providing an alert, when a user has the level 1, the server 31 notifies the PC 21 of a level indicating a “novice alert user” and executes the following process based on the priority of the alert. When the alert has the Hi priority, the server 31 immediately transmits an alert notification. When the alert has the Mid priority, the server 31 collectively transmits alert notifications once a day. When the alert has the Lo priority, the server 31 collectively transmits alert notifications once a week.

When the user has the level 2, the server 31 notifies the PC 21 of a level indicating an “intermediate alert user” and executes the following process based on the priority of the alert. When the alert has the Hi or Mid priority, the server 31 immediately transmits an alert notification. When the alert has the Lo priority, the server 31 collectively transmits alert notifications once a week.

When the user has the level 3, the server 31 notifies the PC 21 of a level indicating an “advanced alert user” and immediately transmits an alert notification, regardless of the priority.

Example 2-3, Option B3: Visualization of Current Rate of Achieving Requirement for Increase in Level

In Example 2-3, the rate of achieving a requirement for an increase in the level is visualized using a progress bar.

FIG. 15C illustrates an example of the screen display in a case where an option B3 according to Example 2-3 of the embodiment is applied. In the example illustrated in FIG. 15C, the visualizing section 25 uses the progress bar to display the fact that the rate of achieving the requirement for the increase to the next level is 70%. By using the progress bar, it is expected that the user spontaneously performs a task.

In FIG. 15C, a method of handling alerts based on the priorities in order to increase a level to the next level is displayed under the progress bar.

Next, a process flow according to the aforementioned embodiment is described.

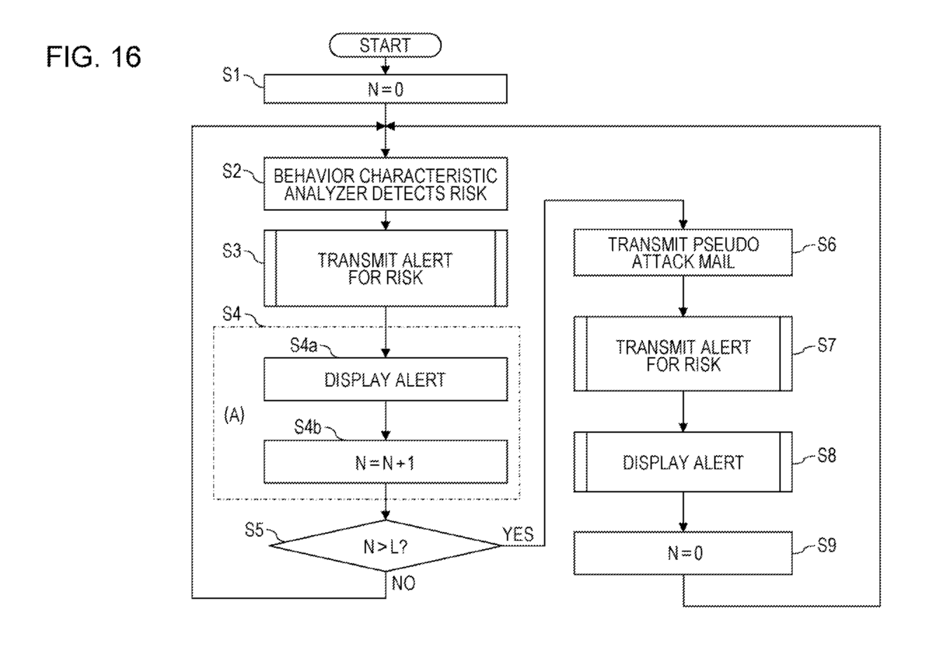

FIG. 16 illustrates the whole process flow according to the embodiment. It is assumed that the PC 21 executes the process by causing the control device 22 of the PC 21 to function as the behavior characteristic analyzer 23, the alert display section 24, or the visualizing section 25. It is assumed that the server 31 executes the process by causing the control device 32 of the server 31 to function as the alert transmitter 33, the pseudo attack transmitter 34, the skipping detector 35, or the point setting section 36.

In the server 31, a threshold L is set at an arbitrary number of times. For example, when L=9, a pseudo attack mail is transmitted for 10 alerts in the flow illustrated in FIG. 16. The flow illustrated in FIG. 16 is described in detail below.

The server 31 initializes a parameter N to 0 (in S1). The behavior characteristic analyzer 23 detects, from a user operation, a risk to the operation and notifies the server 31 of the detected risk (in S2).

Upon receiving the notification from the PC 21, the server 31 transmits alert information for the risk to the PC 21 (in S3). Upon receiving the alert information, the PC 21 displays the received alert information on the display device (in S4a). In this case, the server 31 increments N by 1 (in S4b).

The server 31 determines whether or not N >the threshold L (in S5). When N the threshold L (“NO” in S5), the process returns to S2. When N >the threshold L (“YES” in S5), the server 31 transmits a pseudo attack mail to the PC 21 (in S6). In this case, the server 31 transmits alert information for the risk to the PC 21 (in S7).

Upon receiving the pseudo attack mail and the alert information, the PC 21 displays the received pseudo attack mail and the received alert information on the display device via the mail system. In addition, the PC 21 displays the alert screen based on the alert information on a pop-up window or the like on the mail system (in S8). After that, the server 31 initializes N to 0, and the process returns to S2.

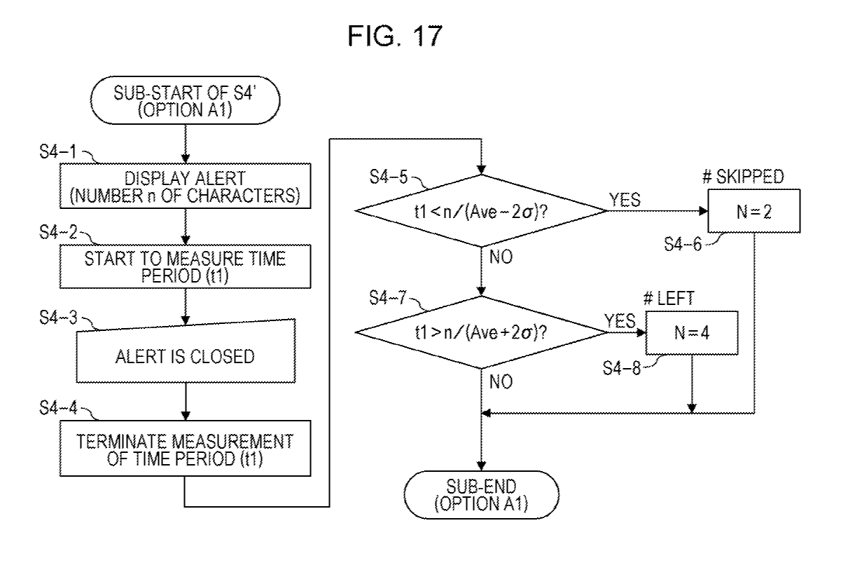

FIG. 17 illustrates a process flow to be used in the case where Example 1-1 (option A1) is applied. In the case where the option A1 is applied, the processes (indicated by a broken line) of S4 included in the flow illustrated in FIG. 16 are replaced with the flow illustrated in FIG. 17. In this case, it is assumed that an initial value of L is 1. As described above, the user characteristic DB 61 stores the average Ave of confirmation time periods and a deviation 6 for each user.

Upon receiving the alert information (number n of characters) for the risk from the server 31, the PC 21 displays the alert screen based on the alert information, on the display device (in S4-1).

The server 31 starts to measure the time period t1 from a time when the alert screen is displayed on the display device to a time when the alert screen is closed (in S4-2).

When the alert screen is closed by a user operation (in S4-3), the PC 21 notifies the server 31 that the alert screen has been closed. Then, the server 31 terminates the measurement of the time period t1 (in S4-4).

The server 31 uses the average Ave of confirmation time periods and a deviation 6 to determine whether or not t1<n/(Ave−2σ) (in S4-5). When t1<n/(Ave−2σ) (“YES” in S4-5), that is, the server 31 determines that the user skipped the alert information, the server 31 sets N at 2 (in S4-6).

When t1 >n/(Ave−2σ) (“NO” in S4-5, “YES” in S4-7), that is, the server 31 determines that the user has left the alert information, the server 31 sets N at 4 (in S4-8).

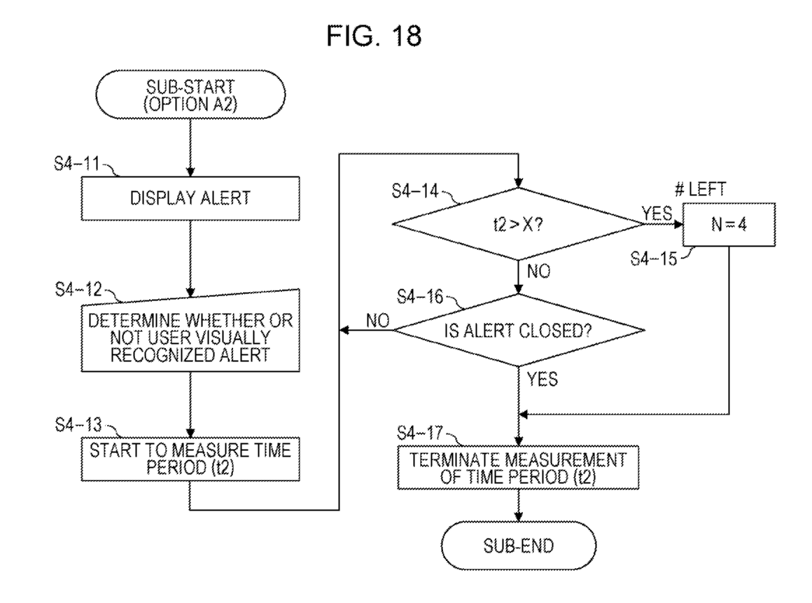

FIG. 18 illustrates a process flow to be used in the case where Example 1-2 (option A2) is applied. In the case where the option A2 is applied, the processes (indicated by the broken line) of S4 illustrated in FIG. 16 are replaced with the flow illustrated in FIG. 18. In this case, it is assumed that the initial value of L is 1. In addition, X is a value indicating a time to be used to determine whether or not an alert is ignored.

Upon receiving the alert information for the risk from the server 31, the PC 21 displays the alert screen based on the alert, on the display device (in S4-11). The PC 21 determines, based on a sensor included in the PC 21, such as a web camera and a mouse, whether or not the user visually recognized the alert (in S4-12). For example, the PC 21 determines, based on a direction in which the eyes of the user looked at the web camera or the like, a mouse's trajectory by a mouse operation, or the like, whether or not the user visually recognized the alert (in S4-12). When the PC 21 determines that the user visually recognized the alert, the PC 21 notifies the server 31 that the user visually recognized the alert.

Then, the sever 31 starts to measure the time period t2 (in S4-13).

When the alert screen is not closed by the user before the time period t2 exceeds the predetermined time X (“NO” in S4-14, and “NO” in S4-16), the process returns to S4-14. When the alert screen is closed by the user before the time period t2 exceeds the predetermined time X (“NO” in S4-14, and “YES” in S4-16), the server 31 terminates the measurement of the time period t2 (in S4-17).

When the time period t2 exceeds the predetermined time X (“YES” in S4-14), the server 31 sets N at 4 (in S4-15). The server 31 terminates the measurement of the time period t2 (in S4-17).

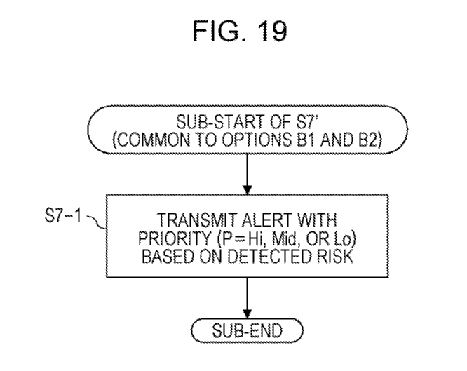

FIG. 19 illustrates a process flow to be used in a case where Examples 2-1 and 2-2 (common to the options B1 and B2) are applied. In the case where the options B1 and B2 are applied, the process of S7 included in the flow illustrated in FIG. 16 is replaced with the flow illustrated in FIG. 19.

The server 31 transmits an alert with a priority (Hi, Mid, or Lo) to the PC 21, based on the risk detected by the PC 21 (in S7-1).

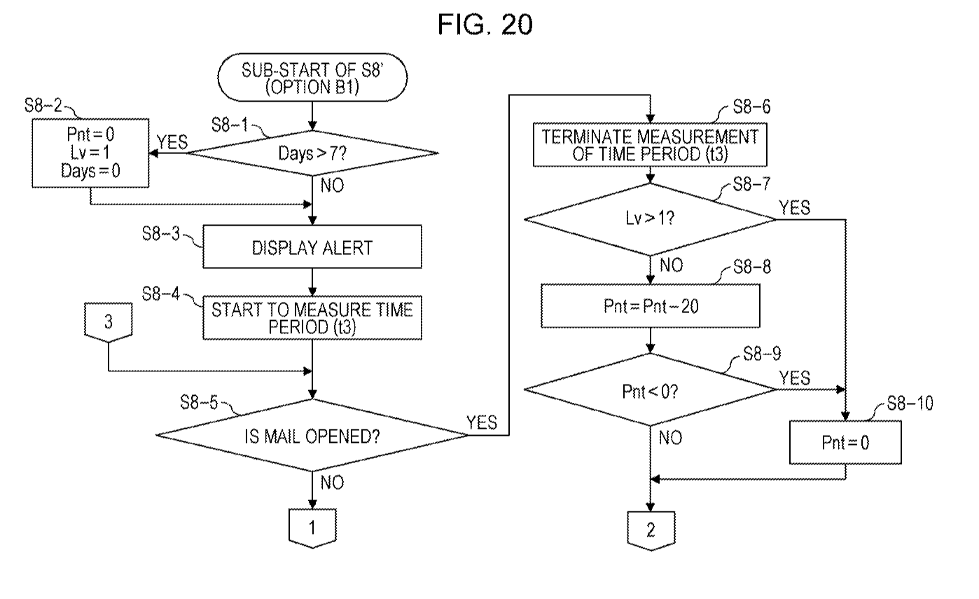

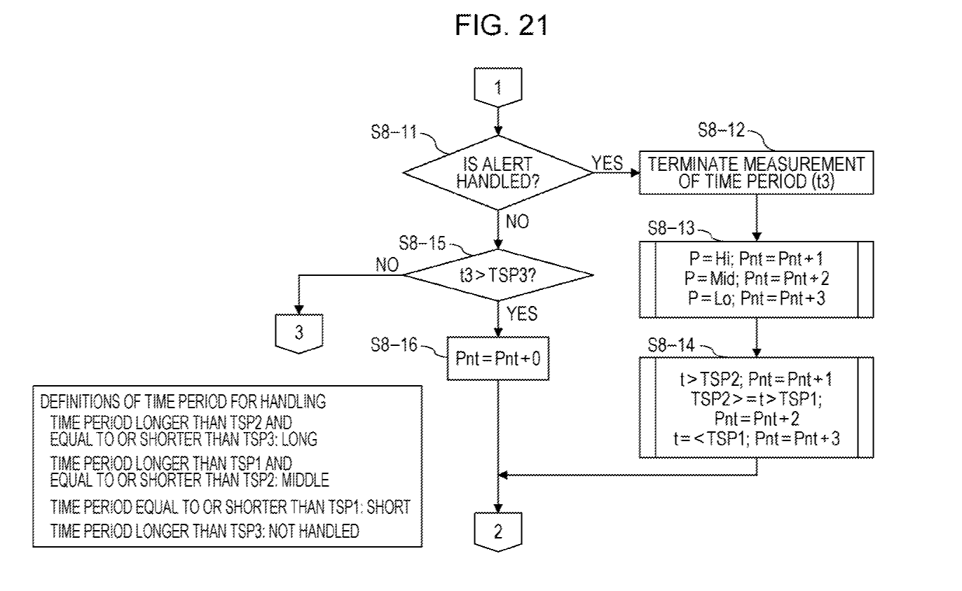

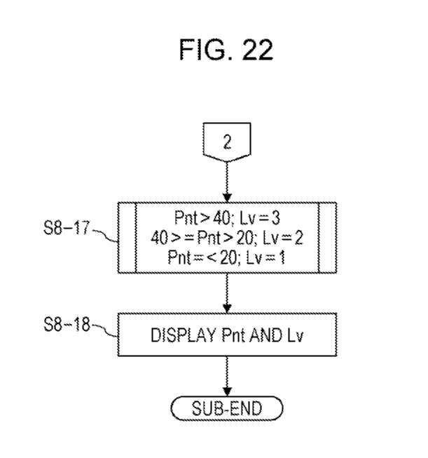

FIGS. 20, 21, and 22 illustrate a process flow to be used in the case where Example 2-1 (option B1) is applied. In the case where the option B1 is applied, the process of S8 included in the flow illustrated in FIG. 16 is replaced with the flow illustrated in FIGS. 20, 21, and 22. In this case, Pnt (the number of points), Lv (level), and Days (for example, 7 or a predetermined time period) are defined in advance. In addition, Days is incremented each time one day elapses. Furthermore, a time period for the handling is defined as follows by using TSP1-3 each indicating threshold for a reaction time of a user:

1) When the time period for the handling is longer than TSP2 and equal to or shorter than TSP3, the time period is defined to be long;

2) When the time period for the handling is longer than TSP1 and equal to or shorter than TSP2, the time period is defined to be middle;

3) When the time period for the handling is equal to or shorter than TSP1, the time period is defined to be short; and

4) When the time period for the handling is longer than TSP3, an alert is not handled. Here,

The server 31 determines whether or not Days >7 (in S8-1). When Days >7 (“YES” in S8-1), the server 31 sets Pnt and Days at 0 and Lv at 1 (in S8-2).

After that, the PC 21 displays, on the display device, the alert screen based on the alert information received from the server 31 (in S8-3). Then, the server 31 starts to measure a time period t3 (in S8-4). When the user has opened the pseudo attack mail, the PC 21 notifies the server 31 that the user has opened the pseudo attack mail.

The server 31 determines, based on the notification received from the PC 21, whether or not the user has opened the pseudo attack mail (in S8-5). When the server 31 determines, based on the notification received from the PC, that the user has opened the pseudo attack mail (“YES” in S8-5), the server 31 terminates the measurement of the time period t3 (in S8-6).

When Lv is larger than 1 (“YES” in S8-7), the server 31 sets Pnt at 0 (in S8-10). After that, the process proceeds to S8-17. When Lv is equal to or smaller than 1 (“NO” in S8-7), the server 31 subtracts 20 points from Pnt (S8-8).

When Pnt becomes smaller than 0(“YES” in S8-9), the server 31 sets Pnt at 0 (in S8-10). When Pnt becomes equal to or larger than 0 (“NO” in S8-9), the process proceeds to S8-17.

When Pnt is larger than 40, the server 31 sets Lv at 3. When Pnt is larger than 20 and equal to or smaller than 40, the server 31 sets Lv at 2. When Pnt is equal to or smaller than 20, the server 31 sets Lv at 1 (in S8-17). The server 31 registers Lv and Pnt in the user management DB 71 and notifies the PC 21 of Lv. In this case, the server 31 may notify the PC 21 of Pnt and the number of points for an increase to the next level.

Upon receiving Lv from the server 31, the PC 21 displays Lv on the display device (in S8-18). When Pnt and the number of points for the increase to the next level are notified, the PC 21 may display Pnt and the number of points for the increase to the next level.

When the server 31 determines, based on the notification received from the PC 21, that the user has not opened the pseudo attack mail (“NO” in S8-5), the server 31 determines, based on the notification received from the PC 21, whether or not the user has handled the alert information (in S8-11).

When the server 31 determines that the user has handled the alert information (“YES” in S8-11), the server 31 terminates the measurement of the time period t3 (in S8-12). In this case, when the priority of the alert is “Hi”, the server 31 adds 1 to Pnt. When the priority of the alert is “Mid”, the server 31 adds 2 to Pnt. When the priority of the alert is “Lo”, the server 31 adds 3 to Pnt (in S8-13).

After the process of S8-13, when the time period t3 is longer than TSP2 and equal to or shorter than TSP3, the server 31 adds 1 to Pnt. When the time period t3 is longer than TSP1 and equal to or shorter than TSP2, the server 31 adds 2 to Pnt. When the time period TSP1 is equal to or shorter than TSP1, the server 31 adds 3 to Pnt (in S8-14). After the process of S8-14, the process proceeds to S8-17.

When the server 31 determines that the user did not handle the alert (“NO” in S8-11), the server 31 determines whether or not the time period t3 is longer than TSP3 (in S8-15).

When the time period t3 is longer than TSP3 (“YES” in S8-15), the server 31 adds 0 to Pnt (in S8-16). After the process of S8-16, the process proceeds to S8-17.

When the time period 3 is equal to or shorter than TSP3 (“NO” in S8-15), the process returns to S8-5.

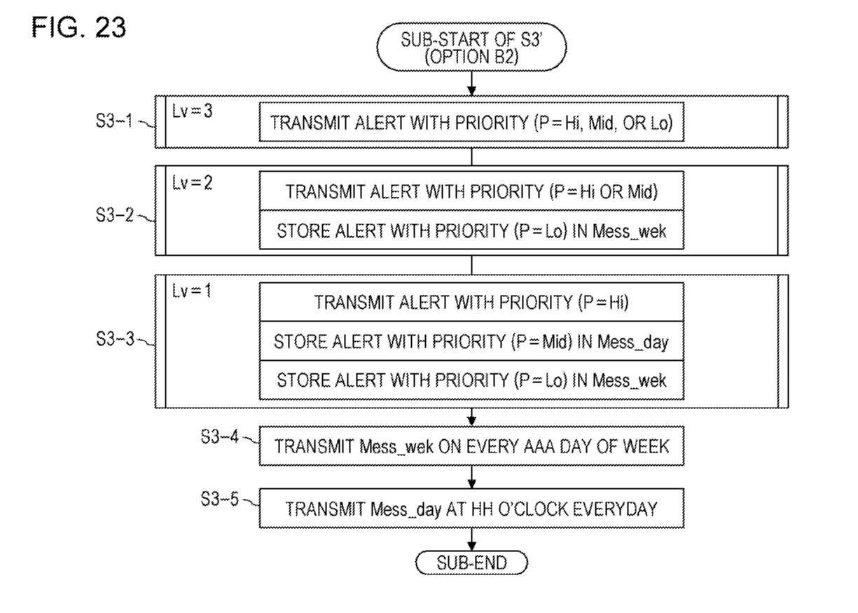

FIG. 23 illustrates a process flow to be used in the case where Example 2-2 (option B2) is applied. In the case where the option B2 is applied, the process of S3 included in the flow illustrated in FIG. 16 is replaced with the flow illustrated in FIG. 23. In this case, the flows illustrated in FIGS. 19 to 22 are applied to the flow illustrated in FIG. 16.

When the level Lv of the user is 3, the alert transmitter 33 of the server 31 transmits an alert with a priority P (P =Hi, Mid, or Lo) (in S3-1).

When the level Lv of the user is 2, the alert transmitter 33 transmits an alert with a priority P (P=Hi or Mid) (in S3-2). In this case, the alert transmitter 33 causes an alert with the priority P (P=Lo) to be stored in Mess_wek (in S3-2).

When the level Lv of the user is 1, the alert transmitter 33 transmits an alert with the priority P (P=Hi). In this case, the alert transmitter 33 causes an alert with the priority P (P=Mid) to be stored in Mess_day and causes the alert with the priority (P=Lo) to be stored in Mess_wek (in S3-3).

The alert transmitter 33 transmits Mess_wek to the PC 21 on every AAA day of week (in S3-4). The alert transmitter 33 transmits Mess_day to the PC 21 at HH o'clock everyday (in S3-5).

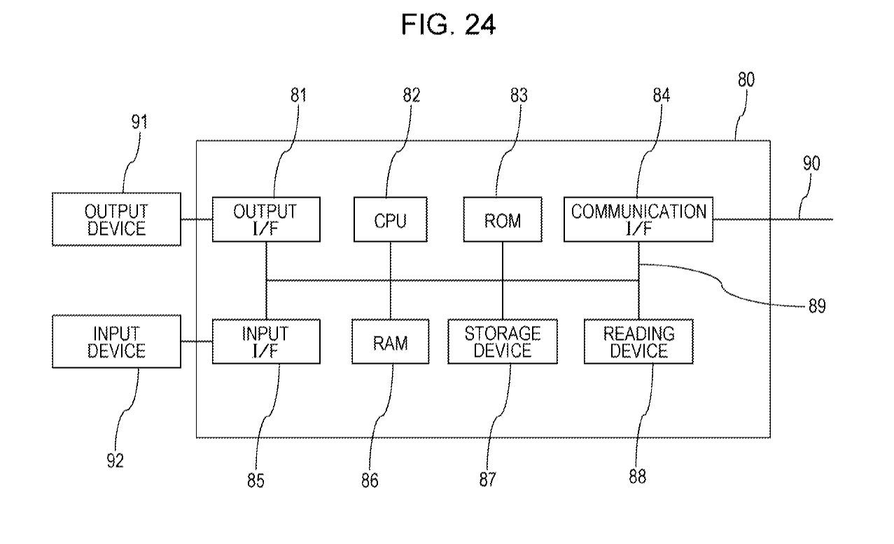

FIG. 24 illustrates an example of a constituent block diagram of a hardware environment of a computer configured to execute the program according to the embodiment. A computer 80 functions as the PC 21 or the server 31. The computer 80 includes a CPU 82, a ROM 83, a RAM 86, a communication I/F 84, a storage device 87, an output I/F 81, an input I/F 85, a reading device 88, a bus 89, an output device 91, and an input device 92.

The CPU is a central processing unit. The ROM is a read only memory. The RAM is a random access memory. The I/Fs are interfaces. The CPU 82, the ROM 83, the RAM 86, the communication I/F 84, the storage device 87, the output I/F 81, the input I/F 85, and the reading device 88 are coupled to the bus 89. The reading device 88 is configured to read a portable storage medium. The output device 91 is coupled to the output I/F 81. The input device 92 is coupled to the input I/F 85.

As the storage device 87, storage devices of various forms such as a hard disk, a flash memory, and a magnetic disk may be used. In the storage device 87 or the ROM 83, the program according to the embodiment that causes the CPU 82 to function as the measuring section 12, the pseudo attack alert providing section 13, and the point output section 14 is stored. Specifically, when the mail system is a web mail system, the following program is stored in the storage device 87 or ROM 83 of the computer 80 serving as a server. Specifically, the program according to the embodiment that causes the CPU 82 to function as the behavior characteristic analyzer 23, the alert display section 24, the visualizing section 25, the alert transmitter 33, the pseudo attack mail transmitter 34, the skipping detector 35, and the point setting section 36 is stored.

When the mail system is not a web mail system, the program that causes the CPU 82 to function as the alert transmitter 33, the pseudo attack mail transmitter 34, the skipping detector 35, and the point setting section 36 is stored in the storage device 87 or ROM 83 of the computer 80 serving as the server. In this case, the program that causes the CPU 82 to function as the behavior characteristic analyzer 23, the alert display section 24, and the visualizing section 25 is stored in the storage device 87 or ROM 83 of a client. The user characteristic DB 61 and the user management DB 71 are stored in the storage device 87.

The CPU 82 reads the program according to the embodiment from the storage device 87 or the ROM 83 and executes the read program.

The communication I/F 84 is an interface that is a port or the like and is coupled to a communication network 90 and configured to communicate with the other device.

The program that is described in the embodiment and achieves the processes may be obtained from a provider of the program via the communication network 90 and the communication I/F 84, and stored in the storage device 87, for example. In addition, the program that is described in the embodiment and achieves the processes may be stored in a distributed and commercially available portable storage medium. In this case, the portable storage medium may be set in the reading device 88, and the program stored in the portable storage medium may be read and executed by the CPU 82. As the portable storage medium, storage media of various forms such as a CD-ROM, a flexible disk, an optical disc, a magneto-optical disc, an IC card, a USB memory device, and a semiconductor memory card may be used. The program stored in the storage medium is read by the reading device 88.

As the input device 92, a keyboard, a mouse, an electronic camera, a web camera, a microphone, a scanner, a sensor, a tablet, a touch panel, or the like may be used. As the output device 91, a display, a printer, a speaker, or the like may be used.

The network 90 may be a communication network such as the Internet, a LAN, a WAN, a dedicated network, a wired network, or a wireless network.

In the examples of the embodiment, the targeted mails are an example of attacks, but may be replaced with other attacks as long as the other attacks are able to be detected by countermeasure software that is used with alerts to be provided to users.

In the embodiment, in order for the users to have motivation to confirm alerts, an event may be intentionally generated. In the embodiment, the result of the event may be visualized, and the users' motivation may be maintained. In the embodiment, a reduction in the motivation to confirm alerts may be determined based on behavior logs.

According to the embodiment, when a user has a tendency to ignore alerts, a pseudo attack mail and an alert are transmitted and a successful or failed experience in avoiding the pseudo attack may be given to the user. As a result, the user may be motivated by the experience, and the ignorance of next alerts may be inhibited. Thus, the rate of ignoring an alert may be reduced.

The embodiment is not limited to the above description and may include various configurations and embodiments without departing from the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process, the process comprising:
measuring, based on an operation performed by a user on first alert information displayed on a display section of a terminal device, a confirmation time period taken for the user to confirm the first alert information; and
outputting, based on the confirmation time period, to the terminal device, pseudo attack information to make or feign an attack against the terminal device, while outputting second alert information including information indicating a method of handling the attack to the terminal device.

2. The non-transitory, computer-readable recording medium of claim 1, wherein
the confirmation time period is a time period from a time when a screen indicating the first alert information is displayed or visually recognized by the user to a time when the screen is closed; and
when the confirmation time period is out of a predetermined time range or is longer than a predetermined time period, the pseudo attack information and the second alert information are output to the terminal device.

3. The non-transitory, computer-readable recording medium of claim 1, the process further comprising:
assigning an point weighted based on a degree of importance to the second alert information;
providing a point to each of users, based on whether the second alert information has been handled by the each user, a time period taken for the each user to handle the second alert information, and whether the each user is trapped by the pseudo attack information; and
outputting the points provided for the users to the terminal device.

4. The non-transitory, computer-readable recording medium of claim 3, wherein
the outputting the points includes outputting, to the terminal device, a graph in which the points are aggregated for each of groups of the users and the groups are ranked based on the aggregated points.

5. The non-transitory, computer-readable recording medium of claim 3, wherein
the outputting the points includes adjusting, based on the points, a frequency at which the second alert information is notified.

6. An alert handling supporting device comprising:
a processor configured to:
measure, based on an operation performed by a user on first alert information displayed on a display section of a terminal device, a confirmation time period taken for the user to confirm the first alert information, and
output, based on the confirmation time period, to the terminal device, pseudo attack information to make or feign an attack against the terminal device, while outputting second alert information including information indicating a method of handling the attack to the terminal device; and
a memory coupled to the processor and configured to store information on the confirmation time period.

7. An alert handling support method comprising:
measuring, based on an operation performed by a user on first alert information displayed on a display section of a terminal device, a confirmation time period taken for the user to confirm the first alert information; and
outputting, based on the confirmation time period, to the terminal device, pseudo attack information to make or feign an attack against the terminal device, while outputting second alert information including information indicating a method of handling the attack to the terminal device.
